(19) United States
(12) Patent Application Publication
(10) Pub. No.: US 2002/0172177 A1
(43) Pub. Date: Nov. 21, 2002

(54) Distributed processing system

(76) Inventor: Simon Gooch, Buckinghamshire (GB)

Correspondence Address: BEYER WEAVER & THOMAS LLP, P.O. BOX 778, BERKELEY, CA, 94704-0778, US

(21) Appl. No.: 10/049,491

(22) PCT Filed: Jun. 13, 2001
(86) PCT No.: PCT/GB01/02580

(30) Foreign Application Priority Data
Jun. 13, 2000 (GB) 0014431.1
Nov. 1, 2000 (GB) 0026740.1

(51) Int. Cl. H04Q 7/24

(52) U.S. Cl. 370/338

(57) ABSTRACT

The present invention provides a distributed processing system which allows a processing stack, such as a Bluetooth stack, to be split between different locations using a communications link. This enables a transceiver to be located in a position within a building so as to provide wireless connectivity to a specified area, whilst a second portion of the processing stack which allows the wireless connections to be controlled can be positioned at a location remote to the transceiver. This allows centralized processing to be achieved, whilst allowing distributed piconets to provide wireless connectivity to other devices over a wide footprint area.

### FIELD OF THE INVENTION

The present invention relates to a distributed processing system for use in a Bluetooth enabled system. The distributed processing system can be used to provide a communications network formed from one or more network node(s) and a network server with processing operations being distributed between the node and the server.

### BACKGROUND TO THE INVENTION

Currently, the majority of computer networks utilize some form of wiring for interconnecting the computers on the network. These systems suffer from the major drawbacks that wiring has to be installed within the building to enable the network to be fitted, and additionally, should a fault with the wiring develop, this can lead to the need for wiring to be replaced. In addition to this, the wiring can cause electromagnetic noise problems due to interference with other electrical equipment within the building, as well as only having a limited bandwidth. Furthermore, different networks require different wiring standards which further leads to the complexity of installing networks in buildings.

Wireless types of networks are now becoming more wide spread. Wireless communication can be broken down into one of three main categories, radio, cellular and local. Radio communications are used for mainly long distance work, and cellular communications are used for mobile phones and the like. At present, the cellular system can also be used to provide limited Internet access using WAP (Wireless Application Protocol) phones. Internet access is also possible via a cellular phone, a GSM modem and a PC/PDA.

In addition to this, the local communication standards are also provided for short-range radio communication. These systems have been used within the production of wireless networks.

One such short-range radio communication radio system is Bluetooth which can be used to provide customer premises wireless links for voice, data and multimedia applications.

A Bluetooth Radio Frequency (RF) system is a Fast Frequency Hopping Spread Spectrum (FFHSS) system in which packets are transmitted in regular time slots on frequencies defined by a pseudo random sequence. A Frequency Hopping system provides Bluetooth with resilience against interference. Interference may come from a variety of sources including microwave ovens and other communication systems operating in this unlicensed radio band which can be used freely around the world. The system uses 1 MHz frequency hopping steps to switch among 79 frequencies in the 2.4 GHz Industrial, Scientific and Medical (ISM) band at 1600 hops per second with each channel using a different hopping sequence.

The Bluetooth baseband architecture includes a Radio Frequency transceiver (RF), a Link Controller (LC) and a Link Manager (LM) implementing the Link Manager Protocol (LMP).

Bluetooth version 1.1 supports asymmetric data rates of up to 721 Kbits per second and 57.6 Kbits per second and symmetric data rates of up to 432.5 Kbits per second. Data transfers may be over synchronous connections, Bluetooth supports up to three pairs of symmetric synchronous voice channels of 64 Kbits per second each.

Bluetooth connections operate in something called a piconet in which several nodes accessing the same channel via a common hopping sequence are connected in a point to multi-point network. The central node of a piconet is called a master that has up to seven active slaves connected to it in a star topology. The bandwidth available within a single piconet is limited by the master, which schedules time to communicate with its various slaves. In addition to the active slaves, devices can be connected to the master in a low power state known as park mode, these parked slaves cannot be active on the channel but remain synchronised to the master and addressable. Having some devices connected in park mode allows more than seven slaves be attached to a master concurrently. The parked slaves access the channel by becoming active slaves, this is regulated by the master.

Multiple piconets with overlapping coverage may co-operate to form a scatternet in which some devices participate in more that one piconet on a time division multiplex basis. These and any other piconets are not time or frequency synchronised, each piconet maintains is own independent master clock and hopping sequence.

The disadvantage with the Bluetooth system is that the Bluetooth radios only have a very short range, typically a few meters. Accordingly, if it is required to provide Bluetooth connectivity over a wide area, such as throughout an airport, company offices or the like, it is necessary to provide a number of separate Bluetooth servers throughout the building. This leads to the formation of a number of independent Bluetooth networks throughout the building. The interconnection of several independent networks is not trivial and requires that the networks are correctly configured for interaction. This means that Bluetooth connectivity cannot readily be provided from one location in the building to another.

### SUMMARY OF THE INVENTION

In accordance with a first aspect of the present invention, we provide a distributed processing system for use in a wireless communications system, the distributed processing system comprising:

at least one transceiver for providing a wireless connection to other wireless communications devices;

a first portion of a processing stack coupled to the transceiver;

a second portion of the processing stack positioned at a location remote to the transceiver; and,

a communication link for interconnecting the first and second portions of the processing stack.

Accordingly, the present invention provides a distributed processing system which allows a processing stack, such as a Bluetooth stack, to be split between different locations using a communications link. This enables the transceiver to be located in a position within a building so as to provide wireless connectivity to a specified area, whilst the second portion of the processing stack which allows the wireless connections to be controlled can be positioned at a location remote to the transceiver. This allows centralized processing to be achieved, whilst allowing distributed piconets to provide wireless connectivity to other devices over a wide footprint area.

In accordance with a second aspect of the present invention, we provide a network node for use in a communications network, the communications network being adapted to communicate with a communications device via a wireless connection, the network node including:

at least one transceiver for communicating with wireless communications device;

a first portion of a processing stack coupled to the transceiver; and, a port for coupling the network node to a network server via a communications link, the network server including a second portion of the processing stack located remotely to the transceiver.

In accordance with a third aspect of the present invention, we provide a network server for use in a communications network, the communications network being adapted to communicate with a communications device via a wireless connection, the network server including:

a port for coupling the network server to a network node via a communications link, the network node including at least one transceiver for communicating with a wireless communications device and a first portion of a processing stack coupled to the transceiver; and, a second portion of the processing stack coupled to the port for communicating with the first portion via the communications link.

The present invention allows network nodes and network servers to be formed with the processing distributed between the node and the server. In this case, a transceiver can be provided at the network node so as to provide wireless access to the network. However, the processing stack, such as a Bluetooth stack, is then split between the network node and the network server so that all processing of Bluetooth commands can be carried out at the server. This in turn allows the server to control a large number of network nodes distributed over a wide area. By controlling the nodes centrally, this allows the wireless connections to be provided to a centralized network.

The first and second portions of the processing stack are usually coupled to the communications link via first and second TCP/IP stacks respectively. The communications link operates to transfer data in a TCP/IP format. This is. particularly advantageous as it allows for the efficient transfer of data using an extremely robust communications protocol. This is important to ensure that there are no errors in the HCl commands transferred thereby ensuring correct operation of the Bluetooth system.

In this case, the system is usually adapted to operate a number of transceivers, with each transceiver being coupled to a respective first processing stack portion. Each first processing stack portion is then coupled to a first TCP/IP stack with the second TCP/IP stack being adapted to provide a virtual connection to each first TCP/IP stack. Accordingly, this allows a single second processing stack portion to control a number of first processing stack portions so that each processing stack may function independently from the others. This allows each transceiver to be controlled separately.

In this circumstance, the first TCP/IP stacks are typically coupled to the second TCP/IP stack in series. This is particularly useful as it allows power to be transferred from a power supply at the remote location, via the communications link, to the at least one transceiver and the first portion of the processing stacks. However, parallel connections could alternatively be used.

Typically the communications link is an Ethernet connection. This is particularly advantageous as many buildings already incorporate Ethernet connections which could be reused in the implementation of the present invention.

In the situation in which the distributed processing system is used in a communications network, the communications network therefore normally consists of a number of network nodes coupled to the network server in series. Again, the power supply may be provided at the network server so that power is transferred to the network nodes via the communications network.

When the wireless communication is carried out in accordance with the Bluetooth protocol, the processing stack is a Bluetooth stack and the transceiver is adapted for Bluetooth communication. In this case, the first and second portions of the Bluetooth stack are typically split at the HCl layer such that control commands can be transferred via the communications link are generated in the HCl format. This is preferable as this reduces to a minimum the amount of information that is transferred via the communications link. In any event, Bluetooth stacks normally require a RS232 connection over which HCl format commands are transferred, and the present invention advantageously utilizes this division which is already present within the Bluetooth stack.

### BRIEF DESCRIPTION OF THE DRAWINGS

Examples of the present invention will now be described in detail with reference to the accompanying drawings, in which:

FIG. 1 is a schematic diagram of a network utilizing distributed processing according to the present invention;

FIG. 2 is a schematic diagram of the Access Server of FIG. 1;

FIG. 3 is a schematic diagram of the Access Point of FIG. 1; and,

FIG. 4 is an example of the functionality of the network shown in FIG. 1.

### DETAILED DESCRIPTION

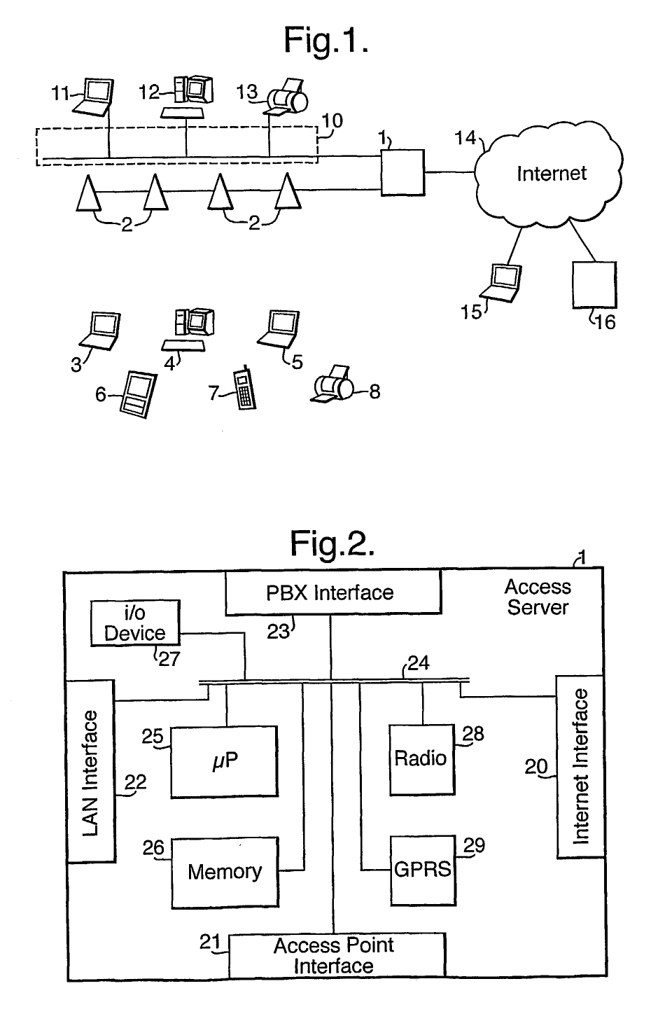

FIG. 1 shows a basic network arrangement which includes a wireless Internet Access Server 1 which is coupled to a number of local area network Access Points 2. The Access Points 2 are designed to communicate with a number of wireless communications devices 3,4,5,6,7,8 using a wireless communications protocol, which in this example is the Bluetooth protocol.

The wireless communication devices 3,4,5,6,7,8 can include devices such as a personal computer, laptop or the like which is fitted with a Bluetooth adapter, a specialised Bluetooth laptop, a Bluetooth enabled phone or mobile phone, a WAP Internet phone, a Bluetooth enabled printer, a Bluetooth enabled personal data assistant (PDA) or a Bluetooth headset. In this example, each of these devices will be able to communicate with the Access Points thereby allowing the devices to obtain data from, or send data to the Access Server.

In fact, the Access Server and Access Points can communicate with any Bluetooth enabled device. These include not only PCs, PDAs, and laptops but any of the following that have a Bluetooth port; a truck, a refrigerator, a baggage trolley, a keyboard etc.

The Access Server 1 is also optionally connected to a local area network 10 having a number of end stations 11,12,13. In this example, this allows the Access Server to be integrated with currently existing local area networks within a building.

The Access Server 1 can also be connected to a remote communications network 14, which in this example is the Internet. This allows the communications devices coupled to the Access Server to communicate with remote users 15 or Access Servers of other remote sites 16.

Accordingly, the Access Points 2 allow the wireless communications devices 3,4,5,6,7,8 to communicate with the LAN 10 and the Internet 14 via the Access Server 1. The Access Server will typically operate as a network server and can therefore typically store information to be retrieved by the communications devices, including information downloaded from the Internet.

The Access Server is shown in more detail in FIG. 2.

The Access Server includes an Internet interface 20, an Access Point interface 21, a LAN interface 22 and a PBX interface 23, all of which are interconnected via a bus 24. A microprocessor 25 and a memory 26 which are provided for processing and storing the operating software, are also coupled to the bus 24. An input/output device 27 is also provided.

The processor 25 is typically an x86 type processor operating a Linux type operating system such as Red Hat Linux. This is particularly advantageous as the Linux system is widely used as the operating system for a number of different software applications. Accordingly, the system can implement a wide variety of standard operating software for network servers and the like, as well as allowing third parties the opportunity to modify existing software and develop their own software. However, any suitable form of processing system may be used.

In addition to these features, it is also possible to include a number of Bluetooth radios 28, and a GPRS transceiver 29, both of which are coupled to the BUS 24.

A range of radios are supported, including standard and enhanced range devices.

Similarly, the Bluetooth design of the Access Server and the Access Point offers capabilities beyond the basic Bluetooth specification. These include advanced control of Bluetooth device state to improve throughput, and control of broadcast and multicast traffic streams to/from Bluetooth devices.

In this example, four different interfaces 20,21,22,23 are shown. However, it is not essential for the Access Server 1 to include all of these interfaces, depending on the particular configuration which is to be used, as will be explained in more detail below.

Thus, in order to enable Bluetooth communication between the wireless communication devices and the Access Server, only the Access Point interface 21, with appropriately connected Access Points 2, is required. In this case the Internet interface 20, the LAN interface 22 and the PBX interface 23 are not necessarily required. Alternatively, the Access Point interface need not be used if the Bluetooth radios are used instead. However, this will become clearer when various network configurations used by the Access Server are described in more detail below.

The Internet interface 20 is used primarily for providing an ISDN connection to an Internet service provider. However, the system can be reconfigured to use Ethernet, DSL or a POTS modem for Internet connectivity.

The Access Point interface 21 is effectively an Ethernet interface which is adapted to operate with the Access Points, as will be explained in more detail below.

The LAN interface 22 is normally configured to be an Ethernet interface. However, this can be adapted to provide token ring or other forms of communication as required. Accordingly the LAN 10 can comprise an Ethernet, Token Ring or other similar network.

In order to be able to handle different communications protocols, each of the interfaces 20,21,22 will include a processor and a memory. The processor operates software stored in the memory which is appropriate for handling the required communications protocol. Thus in the case of the LAN interface 21, the default protocol is Ethernet. However, if alternative protocols such as Token Ring or ATM are used, then the software is adapted to translate the format of the data as it is transferred through the respective interface.

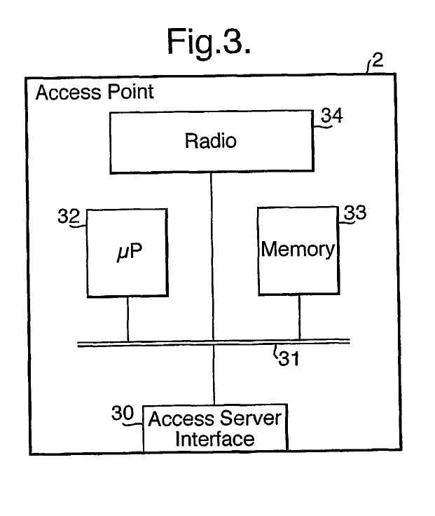

An Access Point according to the present invention is shown in FIG. 3. The Access Point includes an Access Server interface 30, for connecting the Access Point to the Access Server. The Access Server interface 30 is connected via a BUS 31 to a processor 32 and a memory 33. The BUS is also coupled to a number of Bluetooth radios 34 (only one shown) providing enhanced capabilities such as improved bandwidth and call density.

The processor 32 is typically a processor system that can include one or more processors, of the same or different types within the system. For example, the processor system could include, but is not be limited to, a RISC (Reduced Instruction Set Computer) processor and a DSP (Digital Signal Processor) processor.

In use, the Access Points are usually connected to the Access Point interface 21 using a daisy chain Ethernet connection. This is particularly advantageous as it allows a large number of Access Points 2 to be connected in series via a single wire to the Access Point interface 21. In this case, power can be supplied to the Access Points 2 either via the connection from the Access Server 1, or via separate power supplies (not shown) connected to each of the Access Points 2 as required.

As an alternative however, the Access Points 2 could be connected to the Access Server 1 via an Ethernet hub.

In use, each Access Point 2 is able to communicate with a number of communications devices 3,4,5,6,7,8 which are in range of the respective radio 34. Any data received at the radio is transferred to the memory 33 for temporary storage. The processor 32 will determine from the data the intended destination. If this is another Bluetooth device within range of the Access Point, the data will be transferred via the radio 34 to the appropriate communications device 3,4,5,6,7,8. Otherwise the data will be transferred via the BUS 31 to the Access Server interface 30 and on to the Access Server 1.

Upon receipt of the data by the Access Server 1, the Access Point interface 21 will temporarily store the data in the memory whilst the processor determines the intended destination of the data. The processor may also operate to translate the format of the data, if this is necessary. The data is then routed by the Access Server to the intended destination on either the LAN 2, the Internet 14 or alternatively, to a PBX network, as will be described in more detail below.

The traffic from Bluetooth devices (arriving through an Access Point or the Access Server) can be sent to the LAN through a number of different mechanisms; one is routing, another uses a technique called Proxy ARP to reduce the configuration needed. These mechanisms are bi-directional and also connect traffic from the LAN to Bluetooth devices.

Similarly, data can be transferred from the Access Server, via the Access Point interface 21 to an Access Point 2. In this case, the Access Point 2 receives the data and transfers it into the memory 33. The processor 32 then uses the data to determine the intended destination communication device before routing the data appropriately.

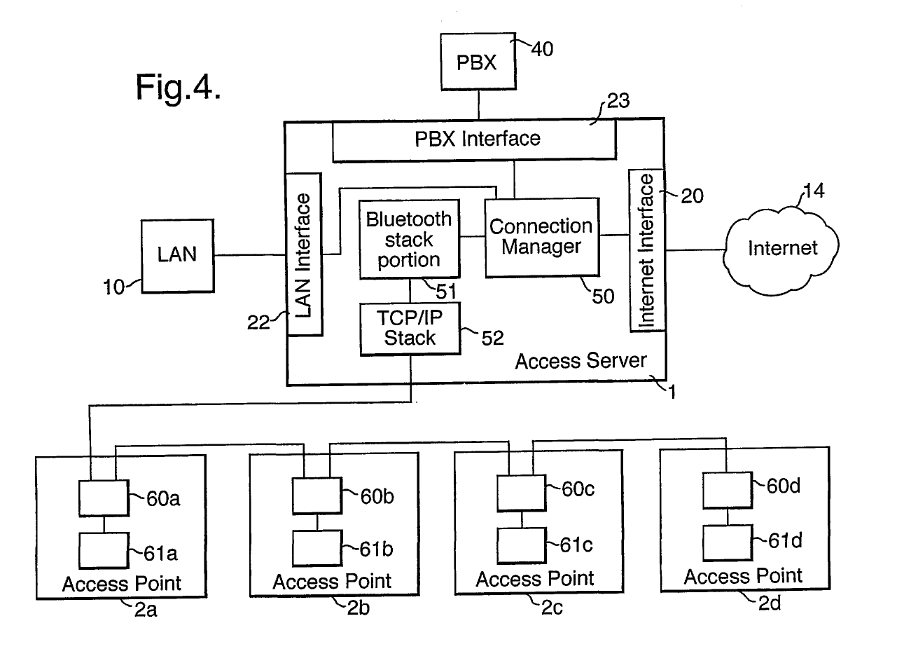

The functionality of the operation of the Access Server 1 and the Access Point 2, in accordance with the present invention will now be described with reference to FIG. 4.

In this example, in order to allow the system to function correctly the operation of the Bluetooth connections via the Access Points 2a,2b,2c,2d is controlled by the Access Server 1. Under normal circumstances, a Bluetooth connection is controlled using a Bluetooth stack which operates to generate commands for controlling the operation of the Bluetooth radios, as well as to translate data into a format suitable for transfer via a Bluetooth connection. Thus, in order to achieve the distributed processing of the present invention, each Access Point 2a,2b,2c,2d includes a respective first Bluetooth stack portion 61a,61b,61c,61d. Similarly, the Access Server includes a respective second Bluetooth stack portion 51. Thus, in this situation, the Bluetooth stack is effectively split between the Access Points 2a,2b,2c,2d and the Access Server 1, as will be described in more detail below.

Thus, as shown in this example, the Access Server 1 includes a connection manager 50 which is coupled to the Internet interface 20 (and hence Internet 14), the LAN Interface 22 and the PBX Interface 23 (and hence PBX 40), as well as being coupled to the second Bluetooth stack portion 51 and a TCP/IP stack 52, as shown. The connection manager is a software implemented device which is typically implemented using the processor 25.

The second Bluetooth stack portion 51 and TCP/IP stack 52 are also software implemented and again this may be achieved by the processor 25. More typically however, the second Bluetooth stack portion and the TCP/IP stack are implemented by the processor in the Access Point interface 21. However, this is not important for the operation of the present invention.

In use, the connection manager 50 operates to provide control signals for controlling the operation of the Internet interface 20, the Access Point interface 21, the LAN interface 22 and the PBX interface 23. Similarly, the connection manager 50 controls the transfer of data through the Access Server 1.

As also shown in FIG. 4, the Access Points 2a,2b,2c,2d include respective TCP/IP stacks 60a,60b,60c,60d and respective first Bluetooth stack portions 61a,61b,61c,61d. Again, the TCP/IP stacks 60a,60b,60c,60d and the first Bluetooth stack portions may be implemented within the Access Server interface 30, or within the processor 32 of the respective Access Point 2a,2b,2c,2d.

The operation of one of the Access Points 2 and the Access Server 1 will now be described. Data received at the Access Point 2, via the Bluetooth radio 34, is typically temporarily stored in the memory 33 before being transferred to the processor 32. At this stage, the second Bluetooth stack portion 61 is used to place the data into the Bluetooth HCl (Host Controller Interface) format suitable for transmission over a connection, such as an RS232 connection, in accordance with the Bluetooth specification.

In the present example, the data is transferred to the respective TCP/IP stack 60 which converts the data into a format suitable for transmission over the Ethernet connection to the Access Server 1. The data is then transferred in accordance with normal Ethernet procedures.

Upon receipt of the data at the Access Server 1 the data is transferred to the TCP/IP stack 52 which converts the data back into the Bluetooth HCl format for transfer over an RS232 connection to the second Bluetooth stack portion 51. The second Bluetooth stack portion 51 operates to translate the data from HCl format into the basic payload data which can then be transferred onto one of the Internet interface 20, the LAN interface 22 or the PBX interface 23.

Transfer of data from the Access Server 1 to one of the Access Points 2 occurs in a similar manner and will therefore not be described in detail.

In addition to the features described above, if the Access Server 1 is coupled to a number of Access Points 2a,2b,2c,2d then it is typical for the TCP/IP stack 52 to provide virtual connections to each of the TCP/IP stacks 60a,60b,60c,60d. In this manner, data received at the TCP/IP stack 52 can be transferred directly to the respective destination TCP/IP stack 60A,60b,60c,60d via the virtual connection. This virtual connection helps ensure that the data is transferred quickly and without errors thereby helping maintain the operation of the distributed Bluetooth processing.

As a further point, the Access Points 2a,2b,2c,2d are connected in series via the TCP/IP stacks 60a,60b,60c,60d, as shown. However, any data received by the TCP/IP stack 60a which is destined for the TCP/IP stack 60b will simply be transferred directly through the TCP/IP stack 60a via the virtual connection. The advantage of connecting the Access Points in series is that power can be supplied to the Access Points via the Ethernet communications link. Accordingly, a power supply can be provided at the Access Server 1 in order to power each of the Access Points 2a,2b,2c,2d respectively.

The routing of the data is achieved in accordance with routing information which is interpreted by the connection manager 50. The connection manager 50 also determines various information about the Bluetooth connection from the second Bluetooth stack portion 51. This typically includes information concerning the signal strength between the Access Points 2 and the communications device 3,4,5,6,7,8 currently connected to the Access Point. The determination of the signal strength can be either a direct determination of the strength of signal that is required to communicate with the communications device, or alternatively or additionally, this may be an indication of the number of errors received per unit time.

Accordingly, as will be appreciated from the above, the Access Server 1 and one of the Access Points 2 will therefore act to provide a Bluetooth connection to the communications device which is controlled by the Access Server 1. In this example, the Access Points 2 function as network nodes, with the Access Server 1 forming the network server to control the operation of the network.

1. A distributed processing system for use in a wireless communication system, the distributed processing system comprising:
at least one transceiver for providing a wireless connection to other wireless communications devices;
a first portion of a processing stack coupled to the transceiver;
a second portion of the processing stack positioned at a location remote to the transceiver; and,
a communication link for interconnecting the first and second portions of the processing stack.

2. A system according to claim 1, wherein the first and second portions of the processing stack are coupled to the communications link via first and second TCP/IP stacks respectively, the communications link operating to transfer data in a TCP/IP format.

3. A system according to claim 2, wherein the system is adapted to operate a number of transceivers, each transceiver being coupled to a respective first processing stack portion.

4. A system according to claim 3, wherein a respective first TCP/IP stack is coupled to each first processing stack portion, the second TCP/IP stack being adapted to provide a virtual connection to each first TCP/IP stack.

5. A system according to claim 4, wherein the first TCP/IP stacks are coupled to the second TCP/IP stack in series.

6. A system according to any of the preceding claims, wherein the communications link is an Ethernet connection.

7. A system according to any of the preceding claims, the system further comprising a processor coupled to the second Bluetooth stack portion, the processor being adapted to control the transfer of data via the Bluetooth piconet(s).

8. A system according to any of the preceding claims, a power supply being provided at the remote location, the communications link being adapted to transfer power from the power supply to the at least one piconet and the first portion of the processing stack.

9. A system according to any of the preceding claims, wherein the wireless communications system is a Bluetooth system, the wireless connections being Bluetooth connections and the first and second portions of the processing stack comprising first and second portions of a Bluetooth stack.

10. A system according to claim 9, wherein the first and second portions of the Bluetooth stack are split at the HCl layer such that control commands to be transferred via the communication link are generated in the HCl format.

11. A network node for use in a communications network, the communications network being adapted to communicate with a communications device via a wireless connection, the network node including:
at least one transceiver for communicating with a wireless communications device;
a first portion of a processing stack coupled to the transceiver; and, a port for coupling the network node to a network server via a communications link, the network server including a second portion of the processing stack located remotely to the transceiver.

12. A network node according to claim 11, the node being adapted to communicate via a Bluetooth connection, the first and second portions of the processing stack comprising first and second portions of a Bluetooth stack.

13. A network server for use in a communications network, the communications network being adapted to communicate with a communications device via a wireless connection, the network server including:
a port for coupling the network server to a network node via a communications link, the network node including at least one transceiver for communicating with a wireless communications device and a first portion of a processing stack coupled to the piconet; and, a second portion of the processing stack coupled to the port for communicating with the first portion via the communications link.

14. A network server according to claim 13, the server being adapted to communicate via a Bluetooth connection, the first and second portions of the processing stack comprising first and second portions of a Bluetooth stack.

15. A communications network including a network node according to claim 11 or claim 12 coupled to a network server according to claim 13 or claim 14 via a communications link.

16. A communications network according to claim 15, wherein the communications network includes a number of network nodes coupled to the network server in series.

17. A communications network according to claim 15 or claim 16, wherein a power supply is provided at the network server, the power supply cooperating with the communications link to transfer power to the network node(s).

18. A communications network according to any of claims 15 to 17, the network server and network node(s) forming a wireless communications system having a distributed processing system according to any of claims 1 to 10.
